(19) United States
(12) Patent Application Publication
(10) Pub. No.: US 2022/0203755 A1
(43) Pub. Date: Jun. 30, 2022

(54) Paint Roller Cleaning and Rinsing Platform

(71) Applicant: BFCS Products, LLC, Scottsdale, AZ (US)

(72) Inventor: Christopher Becker, Scottsdale, AZ (US)

(73) Assignee: BFCS Products, LLC, Scottsdale, AZ (US)

(21) Appl. No.: 17/139,639

(22) Filed: Dec. 31, 2020

(51) Int. Cl. B44D 3/00; B08B 13/00

(52) U.S. Cl. CPC B44D 3/006; B08B 13/00

(57) ABSTRACT

In various representative aspects, a cleaning system for paint rollers that also recaptures a paint that is removed from the paint roller during cleaning. The system includes a platform that securely attaches to the top rim of an open paint can and provides a base for vertically fixing a standard paint roller on top of the base so that excess paint can be removed from the roller and recaptured back in the well of the paint can. The exemplary embodiments in this invention offers an improvement over existing systems and methods for 1) cleaning paint rollers and recapturing unused paint from the rollers more efficiently than existing products as well as 2) using the same system to rinse any residual paint from the roller so that the roller can be used again. Efficiently saving paint and rollers saves 1) our environment by reducing waste entering our sewer systems and landfills as well as 2) time and money for painters

### BACKGROUND OF INVENTION

### Field of the Invention

After using a paint roller, a painter typically desires to efficiently recover as much paint from the roller as possible directly into the can and rinse any remaining residual paint from the roller so that the roller can be used again. The present invention relates generally to an apparatus for paint rollers that assists in recapturing paint that is removed from the paint roller during cleaning or rinsing. More specifically, the apparatus comprises a platform that securely attaches to the top rim of an open paint can and provides a base for vertically fixing a standard paint roller on top of the base so that excess paint can be removed from the roller and recaptured back in the well of the paint can. The platform can also be used in a sink so that the paint roller can be rinsed of any residual paint and then dried for future use. The exemplary embodiments in this invention offers an improvement over existing systems and methods for cleaning and rinsing paint rollers and recapturing unused paint from the rollers more efficiently.

### Description of the Related Art

Any discussion of the prior art in the specification should in no way be considered as an admission that the prior art is widely known or forms part of common general knowledge in the field.

Many painting jobs require the use of paint rollers. The typical paint roller consists of a cylindrical roller frame and a cover secured to the outside of the frame. The roller can be attached to a handle or a pole that allows the roller to rotate on a central axis. The typical paint roller applies paint on large flat surfaces, such as walls, rapidly and efficiently. When the roller is rotated in a tray with paint, the cover absorbs a substantial amount of paint. The cover typically comprises an absorbent material such as cloth or a sponge.

Once the roller has been used, a substantial amount of paint usually remains absorbed in the cover. It is desirable to recover and reuse as much of the paint remaining in the cover as possible instead of throwing it away, or down a drain adding unnecessary chemicals to our water systems and landfills.

There are several known ways to clean or extract the excess paint from the roller. One of the most common methods is by scraping or squeegeeing the paint. A typical cleaner utilizes some form of a scraper or a design that includes a cylindrical tube that tightly conforms to the outer surface of the cover. The cleaner is typically placed at one end of the roller and moved across the entire roller squeezing, scraping, and squeegeeing the excess paint from the cover.

But even if the paint is removed from the cover of the roller, it is still difficult to recover excess paint. Ideally, the paint could be returned to the paint can from where it originated. In order to accomplish this task, the roller must be scraped while positioned directly over the open paint can. Scraping the roller while holding the roller in a person's hand or leaving it on the roller handle as shown in U.S. Pat. No. 6,427,274, is not desirable as it would be very difficult to hold and balance the roller over the paint can, time-consuming, untidy, and much of the excess paint would remain on the person's hands and drip outside of the can. Ideally, a platform that can be secured to the top of the paint can that supports the roller vertically so that it can be scraped is desired. Additionally, it is desirable that the platform have a minimal surface area so that as the paint is scraped and extracted, the paint can fall directly into the paint can below while avoiding the platform's surface and once the paint has been maximally cleaned from the roller, the system can easily be transferred to, and stand in, the bottom of a sink so that the roller can be rinsed of any residual paint and then allowed to dry for later use.

Several platforms exist in the prior art. For example, in U.S. Pat. No. 8,317,057 issued to West, a paint roller cleaning system to recapture paint to a paint can is shown. The system includes a base that comprises an outer ring that sits on the outer lip of the paint can and includes a reservoir that sits within the outer ring and includes a vertical roller support that allows the roller to sit vertically within the reservoir. Presumably when excess paint drips downward, it is first retained in the reservoir and then drips back into the paint can through openings in the reservoir. But because of the large amount of surface area in the reservoir, a substantial amount of paint would be retained within the reservoir and not return to the paint can. Additionally, the reservoir sits below the rim level of the paint can; therefore the can cannot be optimally filled. Furthermore, the system will only work with a single, specific-size paint can (e.g., one-gallon or one-quart, but not both), and the system is not designed to be transferred to the bottom of a sink such that the painter can efficiently rinse the roller.

In U.S. Pat. No. 3,707,740 issued to Demers, an apparatus for cleaning paint rollers is shown that uses a frustoconical scraper that squeegees the paint roller and removes paint. The device also includes a reservoir with a base for vertically supporting the roller and collecting the excess paint that is removed. But the apparatus does not provide an efficient way to extract the excess paint and collect it back in the original paint can from where it came.

A similar system is shown in Canadian Patent 2,543,215 issued to Damant. In Damant, combination reservoir and vertical roller support is shown with a cylindrical scraper that directs paint downward into the reservoir. But as with Demers, this device does not provide an effective way to directly deliver the extracted paint back to its original paint can. Much of the paint that is collected in the reservoir adheres to the surface of the reservoir and cannot be returned.

In U.S. Pat. No. 3,373,456 issued to Dalton, a platform that is positioned over a paint can with a support for a paint roller is shown. But in Dalton, the support requires the paint roller to remain affixed to a hand roller so that the metal rod that connects the handle to the roller is inserted in a slot on the platform and would not work for just the roller itself. Additionally, because the roller handle cannot fit into the can, this system could not be used with one-quart cans and it cannot be efficiently transferred to the bottom of a sink and used to rinse the roller.

Similarly, in U.S. Pat. No. 5,515,567 issued to Washburn, a paint cleaning system to recapture paint to a paint can is shown. But Washburn discloses a tool that is awkward to use because it requires a person to hold the scraper with one hand and the roller support with the other hand while balancing the system over the paint can when attempting to recover paint from the roller into the can. It is more desirable to be able to place the roller on a fixed support and enable the user to freely use a single hand to use any market cleaner to clean and rinse paint from the roller.

In U.S. Pat. No. 8,985,125 issued to Schulz, a paint roller cleaner is disclosed. This apparatus includes a flat base with vertical support for securing the paint roller. The base further comprises a series of holes for allowing paint from the roller to escape. But this apparatus is used solely for cleaning paint rollers in sinks and does not provide any means for securing the base to a paint can and recovering paint. The surface area of the base would also collect a substantial portion of the paint and, if attempted to use over a paint can, would direct most of the paint over the can rim and outside the can.

And finally, in U.S. D357,775 issued to Panchuk, a paint roller cleaner set for a attaching to a paint can is shown. The Panchuk apparatus shows a horizontal bar that sits over a paint can with a vertical support for holding a paint roller. But this device does not allow the device to be secured to the ridges of the outer rings of any paint can in a stable fashion. Furthermore, the wide horizontal bar required for balance significantly obstructs the flow of paint into the can and directs the obstructed paint to flow over the rim and outside of the can. Additionally, the system is not stable and does not efficiently transfer to the bottom of a sink such that the roller may be rinsed and dried for future use.

The present invention overcomes the limitations in the prior art in that it offers a solution that provides a paint roller cleaning system that is both easy to install and use, with both larger (one-gallon) and smaller (one-quart) cans, allows a user to collect and restore as much of the excess paint that exists in the paint roller in the original paint can as possible, works well with most market cleaners, and allows the user to use the same system to rinse and dry the paint roller for future use, which will enable painters wanting to protect the environment and save money.

### SUMMARY OF THE INVENTION

The invention is summarized below only for purposes of introducing embodiments of the invention. The ultimate scope of the invention is to be limited only to the claims that follow the specification.

It is an object of this invention to provide a platform for securing a paint roller to a paint can for removing excess paint from the roller and returning it to the paint can.

It is a further object of this invention that the platform includes a base.

It is a further object of this invention that the base comprises a support for securing the paint roller that extends upward from pedestal.

It is a further object of this invention that the support be cylindrical.

It is a further object of this invention that the base includes a plurality of legs that extend outward from the pedestal of the base.

It is a further object of this invention that the legs include a downward-sloping top surface.

It is a further object of this invention that the legs include at least one grove on the bottom surface of each of the legs.

It is a further object of this invention that the legs include a raised portion that extends downward from the outer end of each leg.

It is a further object of this invention that the legs provide minimal surface area on the top surface of the legs so that excess paint that falls from the paint roller during removal does not collect on the legs.

It is a further object of this invention to provide a single leg that comprises a first and second end, with the leg being coupled to the pedestal such that the leg extends outward from the pedestal with the first end and second end being at 180 degrees from each other.

It is a further object of this invention that the leg further comprises a plurality of grooves in the bottom surface of the leg.

It is a further object of this invention that the first and second ends of the leg further comprise a raised portion extending downward from the bottom surface of the leg.

It is a further object of this invention that the leg further comprises a top surface such that the top surface slopes downward toward the bottom surface of the leg.

It is a further object of this invention that the bottom surface of each leg is co-planar with the other legs.

A person with ordinary skill in the relevant art would know that any shape or size of the elements described below may be adopted. Any combinations of suitable number, shape, and size of the elements described below may be used. Also, any materials suitable to achieve the object of the current invention may be chosen as well.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 illustrates a perspective view of an exemplary embodiment of a fully assembled and operational paint roller system of the present invention that utilizes a squeegee as the paint removal element.

FIG. 1A illustrates an alternate perspective view of the embodiment shown in FIG. 1 that utilizes a scraper as the paint removal element.

FIG. 1B illustrates an alternate perspective view the embodiment shown in FIG. 1 with a smaller paint can.

FIG. 2 illustrates a perspective view of an exemplary embodiment of a paint roller support platform that fits on top of a paint can.

FIG. 3 illustrates a top view of the paint roller support platform shown in FIG. 2.

FIG. 4 illustrates a side cross-sectional view of the paint roller support platform shown in FIG. 2.

FIG. 5 illustrates a bottom view of the paint roller support platform shown in FIG. 2.

### DETAILED DESCRIPTION OF THE INVENTION

In the following description, and for the purposes of explanation, numerous specific details are provided to thoroughly understand the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed embodiments may be applied. The full scope of the invention is not limited to the example(s) that are described below.

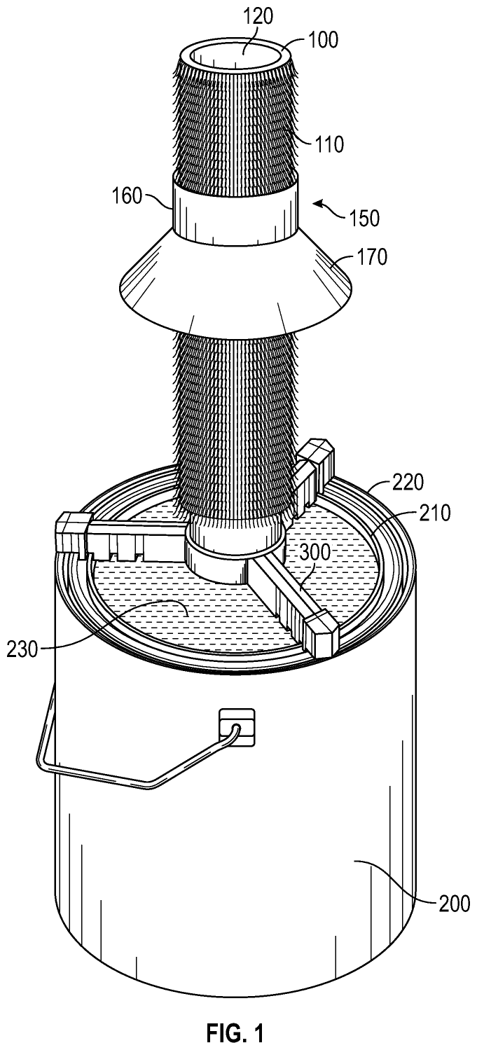

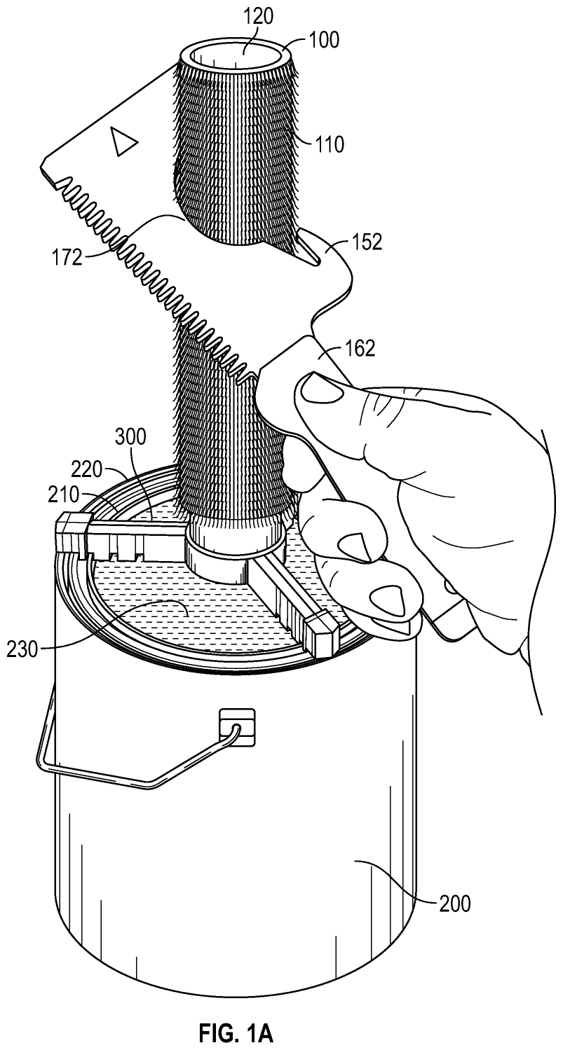

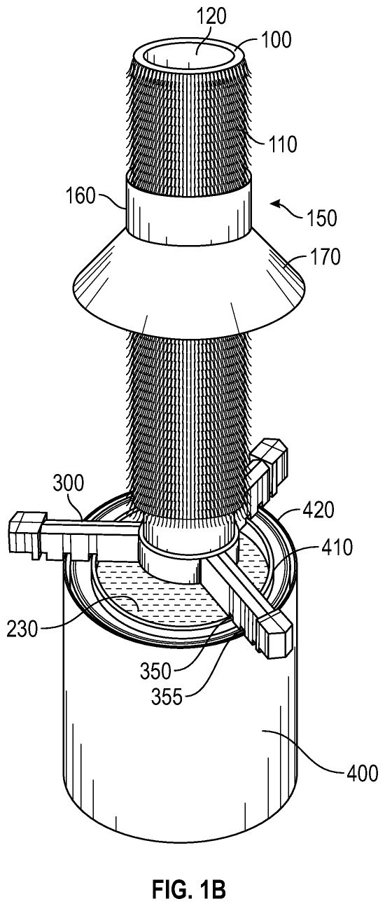

FIG. 1 illustrates a perspective view of an exemplary embodiment of the invention as used. In this embodiment, a generic paint can 200 is shown that is open and includes paint 230 inside of it. The top of the paint can 200 will typically include an inner rim 210 and an outer rim 220 with each forming concentric rings that extend upward from the top of the paint can 200. A platform 300, as will be further described below, is placed on top of the paint can 200 and sits on top of the inner rim 210 and outer rim 220.

A generic cylindrical paint roller 100 is shown with a roller frame 120 and a roller cover 110. The roller cover 110 is typically comprised of a cloth or foam rubber exterior capable of absorbing paint. The paint roller 100 is typically attached to a handle or a rod and is inserted into a paint tray that is filled with paint 230 so that the roller cover 110 is saturated with the paint 230.

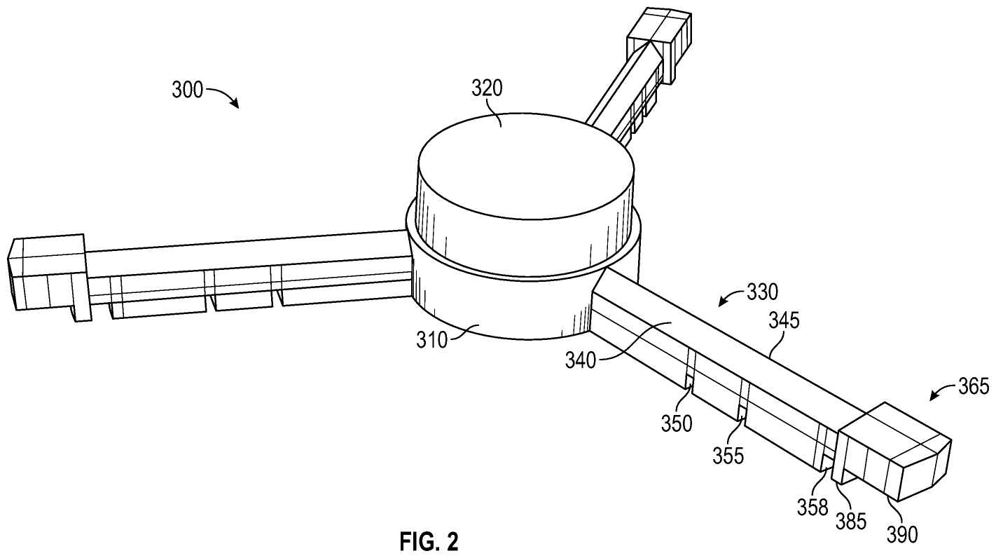

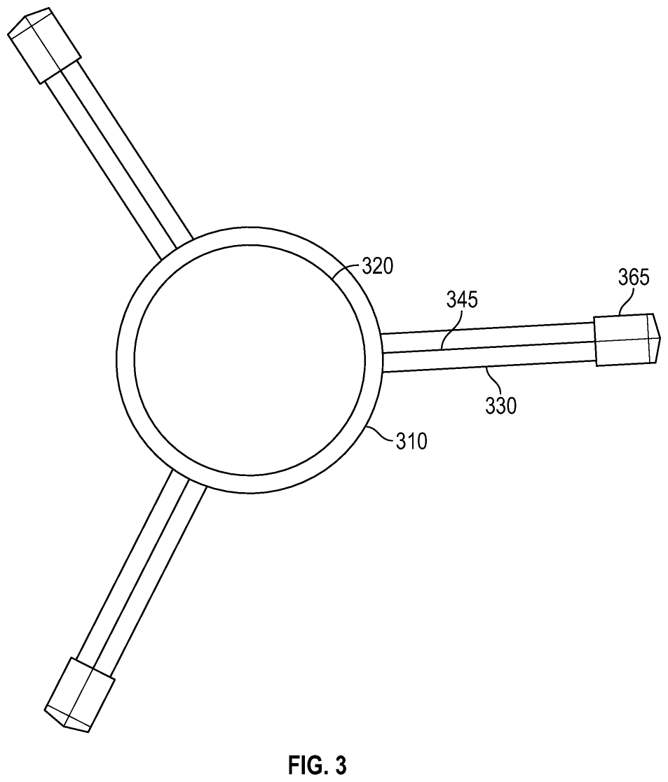

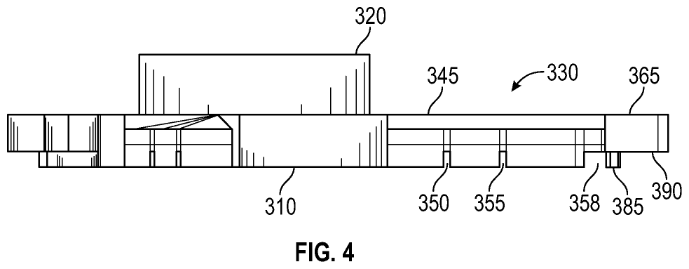

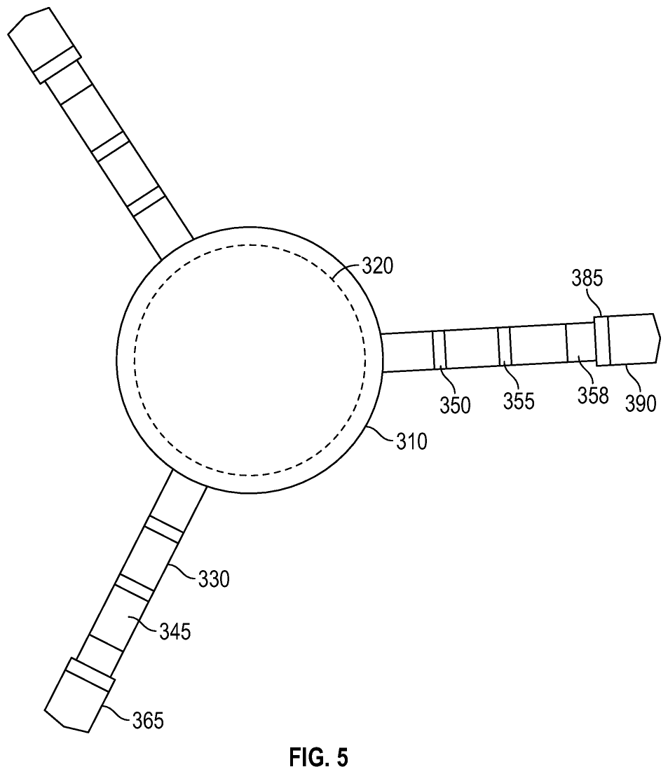

FIG. 2 illustrates a perspective view of an exemplary embodiment of the platform 300. The platform 300 comprises a base 310. The base 310 shown serves as a pedestal and is generally disk-shaped but is not limited to any particular geometrical shape but has a diameter and shape that is sufficient to efficiently remove the paint roller from the roller handle and support the paint roller 100 on the platform 300. A roller support 320 extends upward from the base 310 in a sufficient size to support the paint roller 100. The support 320 is cylindrical and should be of sufficient diameter to fit securely within the roller frame 120. A plurality of platform legs 330 extend outward from the base 310. Each of the legs 330 have a length sufficient to enable the platform 300 to sit on top of the outer rim 220 of the paint can 200. The bottom surface of each leg 330 comprises a flange 385 that extends downward, but not beyond the bottom surface of 310, from the end 365 of the leg 330 and at least one groove 358 that is adjacent the flange 385. The groove 358 and flange 385 are generally curved and enable the leg 330 to fit securely on the paint can 200 with the flange 385 fitting on the outside of the inner rim 210 of the paint can 200 and the inner rim 210 fitting inside the groove 358. The leg end 365 sits on top of outer rim 220. Additional grooves 355 and 350 can also be included on the bottom surface of each leg 330. As shown in FIG. 1B, the additional grooves 355 and 350 can be used to enable the leg 330 to fit securely over the outer rim 420 and inner rim 410, respectively, of the smaller can 400. The top surface of the leg 330 comprises a downward slope 340. The slope 340 extends downward on two sides from an apex 345, but it is understood that the slope 340 can be a singular slope as well. FIGS. 3-5 illustrate different views of the platform 300.

In order to clean the paint roller 100, it is secured vertically on the platform 300. As shown in FIG. 1A, an exemplary paint scraper 152 that is used to clean the paint roller 100 is shown. A typical paint scraper 152 comprises a handle with hand grip 162 to hold the scraper and exert force on the curved scraper blade 172. The curved scraper blade 172 is held at a slight upward angle, pressed to the top edge of the paint roller cover 110, and forced down the side of the paint roller cover 110 until it meets a platform leg 300 or reaches the bottom of the paint roller cover 110—the cleaning stroke. Paint 230 is scraped from the paint roller cover 110 and deposited in the paint can 200 immediately below. At the bottom of the cleaning stroke, the paint scraper 172 is pulled or pushed across the apex 345 of a platform leg 330 to remove any paint 230 still residing on the paint scraper 152. The process is repeated until maximum paint 230 has been removed from the paint roller cover 110. Alternatively, as shown in FIG. 1, a paint scraper 150 comprises a sleeve 160 that is generally cylindrical with a frustoconical hand grip 170 that extends from the sleeve 160. The scraper 150 forms a tight fit around the roller cover 110 and is used by pushing downward on the roller cover 110 to squeeze excess paint 230 from the roller cover 110 and downward into the paint can 200.

A person with ordinary skill in the relevant art would know that any shape or size of the platform and its elements may be adopted as long as they enable the invention to operate as intended. Also, any materials suitable to achieve the objects of the current invention may be chosen.

What is claimed is:

1. A platform for securing a paint roller to a paint can for removing excess paint from the roller and returning it to the paint can comprising:
a. a base, the base comprising:
i. a pedestal; and
ii. a support extending upward from the pedestal such that the width of the support is less than the width of the pedestal;
b. a plurality of legs; each of the plurality of legs comprising:
i. a first and second end with each leg being coupled to the pedestal at the first end and extending outward from the pedestal to the second end of the leg.

2. The platform of claim 1 wherein each of the plurality of legs further comprises a first groove in the bottom surface of the leg.

3. The platform of claim 2 wherein the plurality of legs further comprise a second grove positioned at a radial distance from the pedestal that is less than the position of the first groove.

4. The platform of claim 1 wherein the bottom surface of the plurality of legs are co-planar with the bottom surface of the pedestal.

5. The platform of claim 1 wherein each of the plurality of legs further comprises a flange extending downward from the bottom surface of the leg.

6. The platform of claim 5 wherein the flange extends downward from the bottom surface of the leg at the second end of the leg.

7. The platform of claim 1 wherein each of the plurality of legs further comprises a top surface such that the top surface slopes downward toward the bottom surface of the leg.

8. The platform of claim 1 wherein the support is cylindrical.

9. The platform of claim 8 wherein the support is configured to conform to the inside of a paint roller frame.
